(19) United States
(12) Patent Application Publication
(10) Pub. No.: US 2013/0272868 A1
(43) Pub. Date: Oct. 17, 2013

(54) MOUNTING DEVICE FOR FAN

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/474,729

(22) Filed: May 18, 2012

(30) Foreign Application Priority Data
Apr. 12, 2012 (CN) 201210106294.7

(51) Int. Cl. F04D 29/64; F16M 13/02

(52) U.S. Cl. 415/213.1; 248/615

(57) ABSTRACT

A mounting device for fixing a fan having two opposite boards includes a base board and a number of fixing members mounted to outer surfaces of the boards. The base board forms a number of rods. Each fixing member includes a top plate, and a spring fitted about one of the rods and sandwiched between the base board and the top plate. The top plate defines a fixing hole to fit about the corresponding rod.

### CROSS-REFERENCE TO RELATED APPLICATIONS

Relevant subject matter is disclosed in two pending U.S. patent applications, both titled “MOUNTING DEVICE FOR FAN”, respectively filed on Apr. 13, 2012, with the application Ser. No. 13/445,940, and filed on May 17, 2012, with the application Ser. No. 13/473,631, which are assigned to the same assignee as this patent application.

### BACKGROUND

1. Technical Field

The present disclosure relates to a device for mounting fans.

2. Description of Related Art

Many electronic devices use fans to cool internal electronic components. The fans may be mounted to a rack by a plurality of screws, and then is mounted in an electronic device together with the rack, which adds the additional cost of the rack.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device, together with a plurality of fans, wherein the mounting device includes a plurality of fixing members.

FIG. 2 is an inverted view showing four fixing members mounted to one of the fans of FIG. 1.

FIG. 3 is an assembled, isometric view of the mounting device and the fans of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

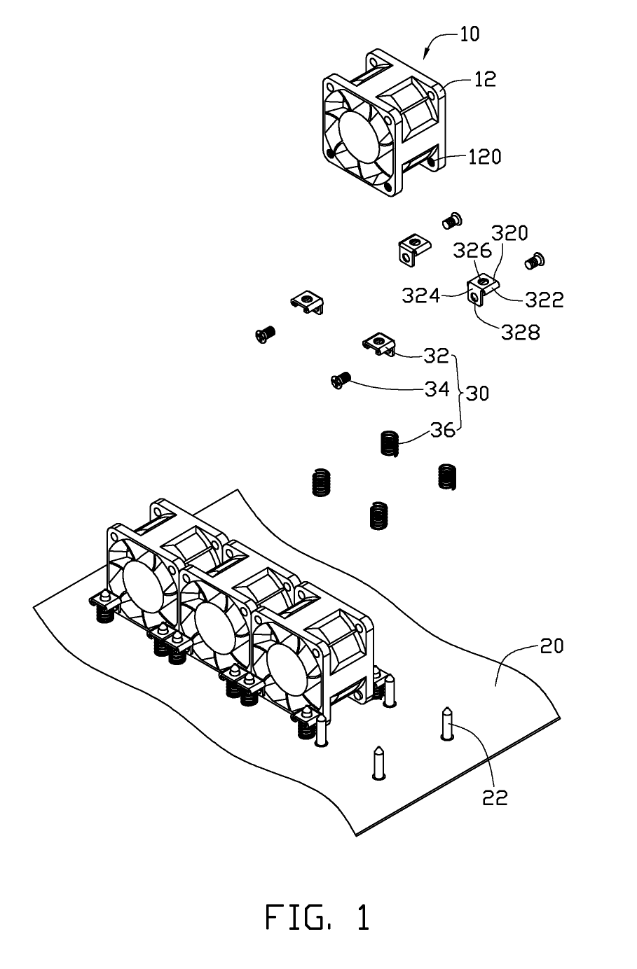

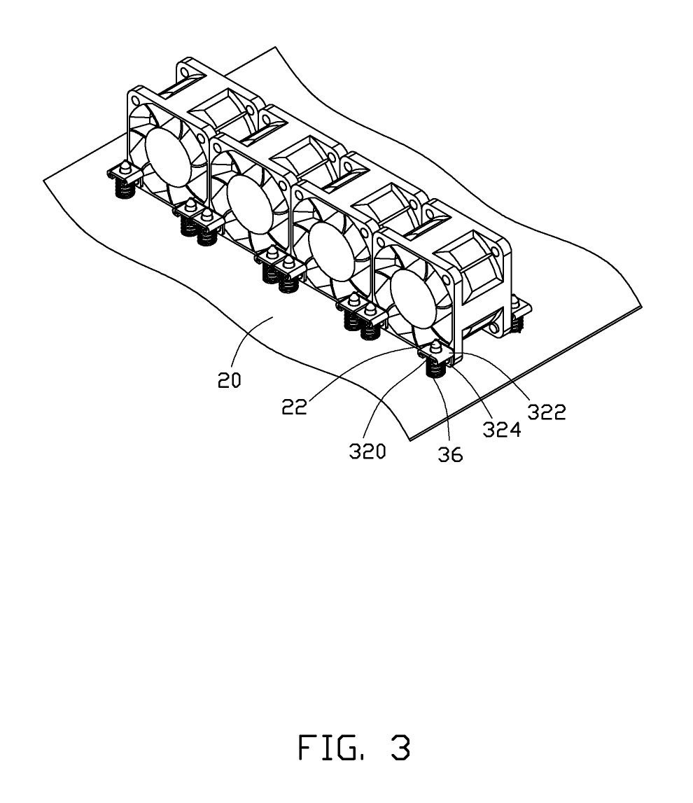

Referring to FIGS. 1 and 3, an exemplary embodiment of a mounting device for fixing a plurality of fans 10 includes a base board 20 and a plurality of fixing members 30.

Each fan 10 includes two spaced boards 12. Each board 12 defines two corner holes 120 in a bottom portion. In the embodiment, the corner holes 120 are threaded holes.

The base board 20 forms a plurality of rods 22. Each rod 22 has a tapered distal end.

Each fixing member 30 includes a block 32, a screw 34, and an elastic member such as a spring 36.

The block 32 includes a top plate 320, two clamping portions 322 extending toward each other from opposite sides of a bottom surface of the top plate 320, and a fixing piece 324 perpendicularly extending down from one of opposite ends of the top plate 320. The top plate 320 defines a fixing hole 326 extending through a top surface and the bottom surface of the top plate 320. The fixing piece 324 defines a threaded hole 328 extending through opposite side surfaces of the fixing piece 324.

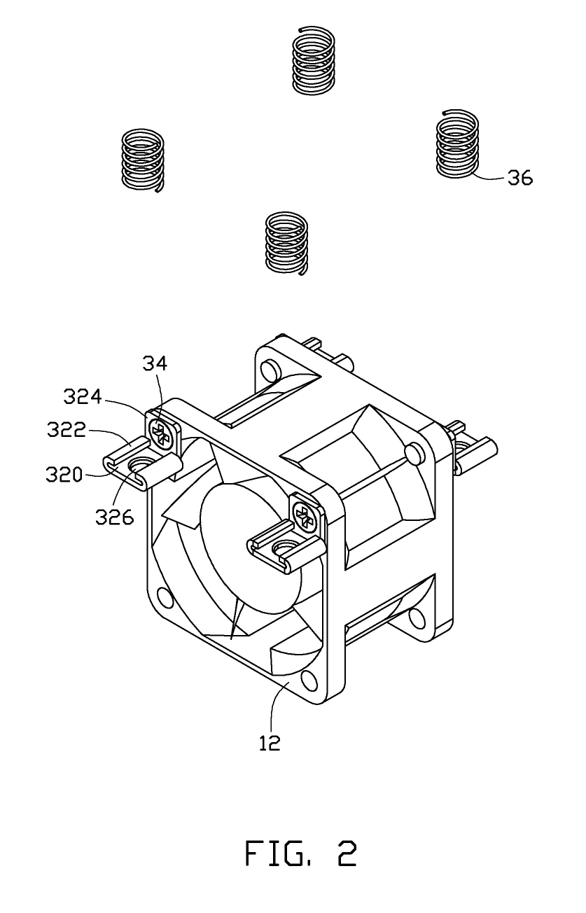

Referring to FIG. 2, in mounting each fan 10 to the base board 20, the threaded holes 328 of four blocks 32 are respectively aligned with the corner holes 120 of the fan 10 from outer surfaces of the corresponding boards 12. Four screws 34 are extended through the threaded holes 328, to be engaged in the corresponding corner holes 120, thereby fixing the blocks 32 to the outer surfaces of the boards 12. A spring 36 is slid from the other opposite end of each block 32 to be sandwiched between the corresponding clamping portions 322, and contacts the bottom surface of the corresponding top plate 320, until the spring 308 is aligned with the corresponding fixing hole 326. The springs 36 and the fixing holes 326 fit about four corresponding rods 22, to fix the fan 10 to the base board 20. Bottom ends of the springs 36 abut against the base board 20. The springs 36 can absorb vibration generated by the fan 10.

In another embodiment, the screws 34 may extend through the corner holes 120 of the fan 10 from a space between the boards 12 and then are engaged into the threaded holes 328, to fix the blocks 30 to the outer surfaces of the boards 12.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a fan having two opposite boards, comprising:
a base board forming a plurality of rods; and
a plurality of fixing members to be mounted to the boards, each fixing member comprising a block having a top plate, and an elastic member fitted about one of the rods and sandwiched between the top plate and the base board; the top plate defining a fixing hole extending through a top surface and a bottom surface of the top plate to be fitted about the corresponding rod.

2. The mounting device of claim 1, wherein each fixing member further comprises a screw, each block further comprises a fixing piece perpendicularly extending down from one of opposite ends of the top plate, the screw extends through the fixing piece to engage in a corresponding one of the boards of the fan.

3. The mounting device of claim 2, wherein each block further comprises two clamping portions extending toward each other from opposite sides of the a bottom surface of the corresponding top plate, an end of the corresponding elastic member is clamped by the two clamping portions.

4. The mounding device of claim 1, wherein the elastic member is a spring.

5. A fan assembly, comprising:
a fan comprising two opposite boards;
a base board forming a plurality of rods; and
a plurality of fixing members mounted to the boards, each fixing member comprising a block having a top plate, and an elastic member fitted about one of the rods and sandwiched between the top plate and the base board; the top plate defining a fixing hole extending through a top surface and a bottom surface of the top plate and fitted about the corresponding rod.

6. The fan assembly of claim 5, wherein each fixing member further comprises a screw, each block further comprises a fixing piece perpendicularly extending down from one of opposite ends of the top plate, the screw extends through the fixing piece to engage in a corresponding one of the boards of the fan.

7. The fan assembly of claim 6, wherein each block further comprises two clamping portions extending toward each other from opposite sides of the a bottom surface of the corresponding top plate, an end of the corresponding elastic member is clamped by the two clamping portions.
